(19) United States
(12) Patent Application Publication
(10) Pub. No.: US 2023/0237558 A1
(43) Pub. Date: Jul. 27, 2023

(54) OBJECT RECOGNITION SYSTEMS AND METHODS

(71) Applicant: GRUBBRR SPV, LLC, Boca Raton, FL (US)

(72) Inventors: Bhavin Asher, Boca Raton, FL (US); Sam Zietz, Boca Raton, FL (US); Farshad Tafazzoli, Boca Raton, FL (US); Smit Patel, Boca Raton, FL (US); Badhri Suresh, Boca Raton, FL (US)

(21) Appl. No.: 17/586,360

(22) Filed: Jan. 27, 2022

(51) Int. Cl. G06Q 30/06; G06V 10/22; G06Q 20/20

(52) U.S. Cl. CPC G06Q 30/0635; G06V 10/22; G06Q 20/208

(57) ABSTRACT

An image sensor is used to capture an image that includes a plurality of objects. Presence and location data is identified for the plurality of objects. The image and the presence and location data is utilized to create individual representations of the plurality of objects. The plurality of objects are classified through employment of the individual representations. A machine learning model is updated with the classification data generated by classifying the plurality of objects.

### BACKGROUND OF THE INVENTION

The use of object recognition systems is prevalent throughout society and especially throughout the world of commerce. Object recognition systems are utilized for a variety of purposes. Sometimes, identifying an object represents an end in itself. For instance, aerial photographs are utilized to identify objects on the ground, and facial recognition systems are used to identify individuals in crowds. Other times, object recognition systems are used as a means to an end. For instance, point of sale (POS) systems may use object recognition systems to identify objects at the point of sale as part of an automated checkout system or as a way to track inventory.

One problem associated with object recognition systems is the cost and complexity of implementation. Not only do object recognition systems require sophisticated algorithms and robust processing power to recognize objects, but they also require sophisticated hardware configurations, including pluralities of optical and image sensors, to capture images. Oftentimes, the optical and image sensors must be supplemented with other technologies, such as radio frequency identification (RFID) and beacon technology, to supplement the image processing technology in order to identify an object. The use of multiple sensors increases the cost of the hardware configuration of object recognition systems and the complexity of the algorithms used within the system.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not constrained to limitations that solve any or all disadvantages noted in any part of this disclosure.

In one embodiment, a method is provided. An image sensor is used to capture an image that includes a plurality of objects. Presence and location data is identified for the plurality of objects. The image and the presence and location data is utilized to create individual representations of the plurality of objects. The plurality of objects are classified through employment of the individual representations. A machine learning model is updated with the classification data generated by classifying the plurality of objects.

In one embodiment, a method is provided. An image sensor is used, at a first location, to capture an image that includes a plurality of objects. The image is sent over a network to a second location. At the second location, presence and location data of the plurality of objects is detected. The two-dimensional image and the presence and location data is utilized to create individual representations of the plurality of objects. The plurality of objects are classified through employment of the individual representations. A machine learning model is updated with classification data generated by classifying the plurality of objects. The machine learning model is sent over the network to the first location.

In one embodiment, an apparatus is provided. The apparatus includes a processor; and a memory coupled with the processor. Executable instructions when executed by the processor cause the processor to effectuate operations. An image sensor is used to capture an image that includes a plurality of objects. Presence and location data of the plurality of objects is detected. The two-dimensional image and the presence and location data is used to create individual representations of the plurality of objects. The plurality of objects are classified through employment of the individual representations. A machine learning model is updated with classification data generated by classifying the plurality of objects.

### BRIEF DESCRIPTION OF THE DRAWINGS

A more detailed understanding may be had from the following description, given by way of example in conjunction with the accompanying drawings wherein:

FIG. 1 illustrates on aspect of an exemplary object recognition system;

FIG. 2 illustrates an exemplary screenshot from a terminal used in the aspect of an object recognition system shown in FIG. 1;

FIGS. 3A and 3B illustrates exemplary objection detection and classification systems; and

FIG. 4 describes an exemplary objection detection and classification process;

FIG. 5 describes interoperability between the systems shown FIGS. 1, 3A, and 3B; and

FIG. 6 is an exemplary block diagram representing a computer system in which aspects of the processes and systems disclosed herein or portions thereof may be incorporated.

### DETAILED DESCRIPTION

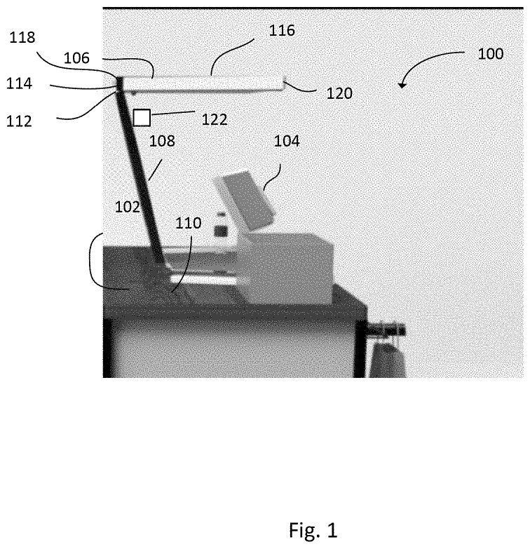

Referring to FIG. 1, a POS 100 system utilizing the object recognition system (ORS) of the presentation application is provided for illustrative purposes. It should be noted at the outset that the configuration of system 100 is provided for illustrative purposes. Implementation of system 100, including the physical and hardware environment, may vary without departing from the scope of this disclosure.

In one example, system 100 includes a base surface 102, a terminal 104, a mount 106. Base surface 102 is utilized by a user of system 100 to place one or more objects thereon. Terminal 104 allows a user or operator to interact with system and may includes one or more input/output devices, such as touchscreens, keypads, and the like. Mount 106 in one embodiment comprises a first arm 108 extending from one end 110 upward at a 45 degrees angle from base surface 102. In one embodiment a second end 112 of first arm 108 is connected through a hinge 114 to a second arm 116. Second arm 116 in one example has a first end 118 and a second end 120. Second arm 116 extends longitudinally from first end 118 to second end 120 along a plane that is parallel to a plane of base surface 102. First arm 108 and second arm 116 may be used to mount hardware components utilized in system 100. In one embodiment first arm 108 includes a sensor 122 mounted thereto and second arm 116 includes a lighting source mounted thereto. It should be noted that the depicted configuration of base surface 102, first arm 108, and second arm 112 is provided for illustrative purposes and could be altered, added to, or subtracted to without departing from the scope of the present disclosure.

Referring further to FIG. 1, sensor 122 in one example comprises an image sensor. Examples of image sensors include digital cameras, camera modules, camera phones, optical mouse devices, medical imaging equipment, night vision equipment such as thermal imaging devices, radar, sonar, and the like. Sensor 122 may capture moving images, such as video, still images, or both. In operation, a user may place one or more objects on base surface 102. Images of the objects are captured by sensor 122. As will be discussed further herein, the images are processed, and through the processing operations, the objects are identified, and information about the objects, such as their price, may then be output to the terminal 104. A user may then perform operations, such as purchasing the objects, by using terminal 104.

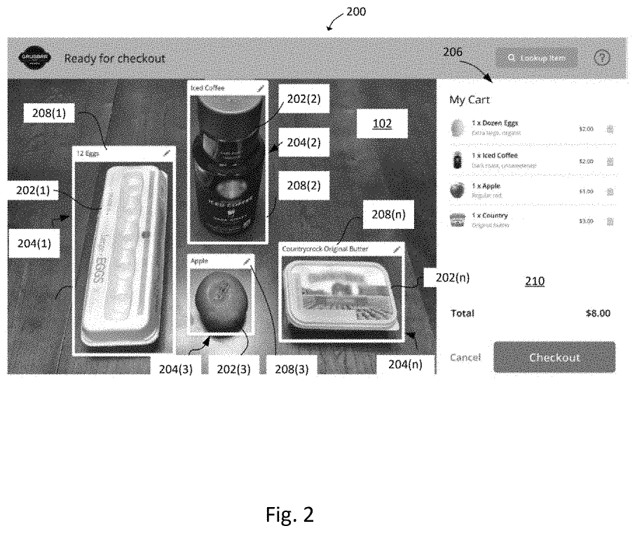

Referring to FIG. 2, an exemplary screen 200 of user terminal 104 (FIG. 1) is shown for illustrative purposes. As was discussed previously, when objects 202(1) . . . 202(n) (where n=4 in FIG. 2) are placed on base surface 102, sensor 122 captures the objects 202(1) . . . 202(n) in one or more images 204(1) . . . 201(n). In one example, images 204(1) . . . 204(n) are 2D images. Processing steps, which will be discussed further herein, operate on the one or more images 204(1) . . . 201(n) to identify the objects 202(1) . . . 202(n). Through processing of the images 202(1) . . . 202(n), information 206 relating to the objects 202(1) . . . 202(n) is output to screen 200. Such information 206 may include the identity of object and pricing information. Other information, such as a product identifier, product origin, and/or inventory amount may be included without departing from the scope of this disclosure. Objects 202 are depicted in FIG. 2 as grocery items, but could be other products (e.g. clothing, manufactured goods, etc.) without departing from the scope of this disclosure. Terminal 104 in one example provides a shopping cart checkout function that allows a customer to purchase the items.

Referring further to FIG. 2, screen 200 includes boundaries 208(1) . . . 208(n). In one embodiment, system 100 identifies each object 202(1) . . . 202(n) and creates boundaries 208(1) . . . 208(n) around objects 202(1) . . . 202(n) on user terminal 104. In the example shown, the boundaries 208(1) . . . 208(n) are rectangular or square boxes. Boundaries 208(1) . . . 208(n) may serve one or more purposes. In one example, boundaries 208(1) . . . 208(n) may mark the extent and location of each object 202(1) . . . 202(n) such that a user can verify that the objects 202(1) . . . 202(n) are correctly identified by system 100. If one or more of the objects 202(1) . . . 202(n) are not correct, then the system 100 can provide the user with the opportunity to correct the objects 202(1) . . . 202(n). In another example, if an object is not highlighted by a box 208(1) . . . 208(n) then a user may interact with system 100 through terminal 104 to notify system 100 that an object 202(1) . . . 202(n) is present, but not accounted for in information 206. As another example, if a user places objects 202(1) . . . 202(n) on base surface 102 in such a way that two or more of objects 202(1) . . . 202(n) interfere with each other such that sensor 108 cannot capture the objects cleanly 202(1) . . . 202(n), then boundaries 208(1) . . . 208(n) may depict such interference and allow the user to reorient the interfering objects.

It should be noted that the functionality, which is executed in connection with FIGS. 1 and 2, may be executed at one or more terminals 104 or may be executed at a server with the results provided to terminals 104 as part of a client/server architecture. In another embodiment, the functionality may be executed in a remote and distributed environment, such as the cloud, and provided to terminals 104. The configurations described herein are provided for illustrative purposes only and should not limit the disclosure provided herein.

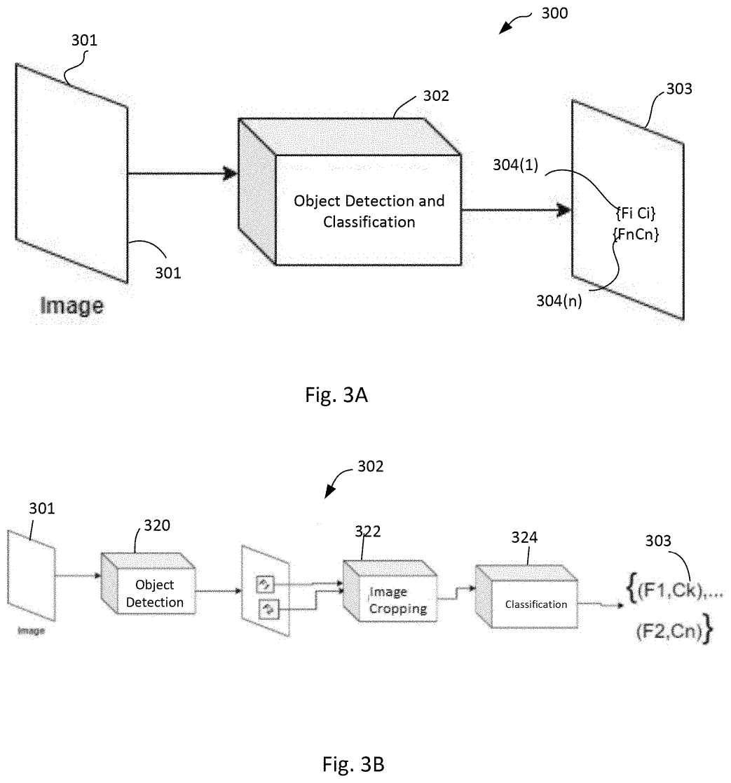

Referring to FIGS. 3A, an exemplary system 300 is now described that processes an image 301 such that objects 202(1) . . . 202(n) may be recognized. Image 301 includes one or more objects 202(1) . . . 202(n). In one embodiment, system 300 comprises an object detection and classification module (ODC) 302. Image 301 is input into ODC 302. ODC 302 comprises one or more hardware and/or software components or modules that execute processes on image 301 to identify and classify objects 202(1) . . . 202(n) that are present in image 301. The output of ODC 302 is a data set 303. In one example, the data set 303 includes an object identity and classification index entry 304(1) . . . 304(n) for each object 202(1) . . . 202(n) in image 301. Identity and classification index 304(1) . . . 304(n) includes an object identifier Fᵢ and a classification Cᵢ. The object identifier Fᵢ in one example is an index i and a position Pᵢ of the object. The index i is an identifier for each object detected in image 301. For example, if there are four objects 202(1) . . . 202(4) in image 301, then i will range from 1 . . . 4. If there are 8 objects 202(1) . . . 202(8), then i will range from 1 . . . 8, and so on. For each value of i, there will be a position Pᵢ of the object 202(i) corresponding to index i. Classification Cᵢ is the classification of the object 202(i) corresponding to the index i, as will be further discussed herein.

Referring now to FIG. 2 and further to FIG. 3A, for the objects 202(1) . . . 202(n) (with n=4) shown in FIG. 2, ODC 302 will output data set 303 including F₁ . . . F₄. F₁ provides the position of object 202(1). F₂ provides the position of object 202(2). F₃ provides the position of object 202(3) and F₄ provides the position of object 202(4). Fi is a pair of rectangular coordinates denoting the left-top and right-bottom corner pixel coordinates of a rectangle respectively which is used to render a box encapsulating the object. For each value of Fᵢ there is a corresponding classification Cᵢ. For example, object 202(1) has a classification C₁ identifying object 202(1) as “Eggs.” Object 202(2) has a classification C₂ identifying object 202(2) as “Iced Coffee”. Object 202(3) has a classification C₃ identifying object 202(3) as “Apple” and object 202(4) has a classification C₄ identifying object 202(4) as “Margarine”. As was discussed above, classification Cᵢ may include information in addition to the identity of object 202(i). For example, price information, a product ID, a product description, a sku, etc. are examples of information that could be included in classification C(i). Further, in one example, some or all of the information included in classification Cᵢ may be output to the user as part of information 206 shown on terminal 104. For example, terminal 104 may use information to create a shopping cart and checkout function 210 for the items placed on base surface 102. It should be noted the output from ODC 302 is described for illustrative purposes only. Different data fields may be added to the output described herein without departing from the disclosure herein. In addition, fields Ci could be divided into multiple fields or subfields. For instance, one field could describe a price and another field could describe the product.

Referring to FIG. 3B, an exemplary embodiment of ODC 302 is shown for illustrative purposes. In one example, ODC 302 includes object detection module 320, image cropping module 322, and classification module 324. Object detection module 320, in one example, processes image 301 such that it is able to locate the presence of discrete objects within image 301. In one example, object detection module 320 is a food detector module that is trained to identify discrete food items base surface 102 using pre-trained weights. The pre-trained weights are a result of training a deep learning model with large-scale generic datasets that contain objects such as vehicles, people and animals. The model is fine-tuned on custom utilizing custom data collected by within training processes described herein to maximize detection accuracy for particular use cases, such as when the majority of the objects are food packets and drinks. The output of object detection module 320 is one or more object identifiers Fᵢ. In one example, an object identifier Fᵢ includes the presence of an object and the location of the object.

Cropping module 322, in one example, utilizes the object identifiers to “crop” the individual objects 202(1) . . . 202(n) located in image 301. To “crop”, in one example, means to create individual images for each of the objects located in image 301. For instance, cropping module 322 may determine coordinate boundaries for an object 202(1) . . . 202(n) and then extract image data from image 301 corresponding to those boundaries. In one example, coordinate boundaries may be provided to terminal 104 (FIG. 2) such that a shape (e.g. 208(1)) may be drawn around one or more of the objects 202(1) . . . 202(n) to mark the boundaries.

The output of the cropping module is image data associated with objects 202(1) . . . 202(n) present in image 204(i). The image data is input to classifier module 324. Classifier module 324, in one example, comprises a machine learning module that is trained to identify objects. In the example classifier is module 324 is trained to identify food items. An embodiment of classifier module 324 has deep learning structure, based on a neural network, which can identify food items. Such a deep learning module may be supervised, unsupervised, or semi-supervised.

Classifier module 324 in one example receives image data corresponding to each object 202(1) . . . 202(n) and compares or superimposes the image data over one or more data sets provided to classifier module 324. For example, there are a number of available data sets (Frieburg Groceries Dataset, UFC Food 256), relating to grocery items, that may be provided to classifier module 324. Classifier module utilizes the image data from an object 202(1) . . . 202(n) with such data sets to identify objects 202(1) . . . 202(n) with precision. Similar to ODC 302, a deep learning architecture model is trained to recognize food items present in the inventory. In one example, the classifier module 324 is trained at the architecture level and then fine-tuned based on custom datasets to optimize its performance. The output of classifier module 324 is data set 303. Data set 303 in one example is then added to a model of objects that are utilized by system 100 (FIG. 1) to identify objects that are placed on base surface 102 during a user's operation of system 100, such as a checkout operation.

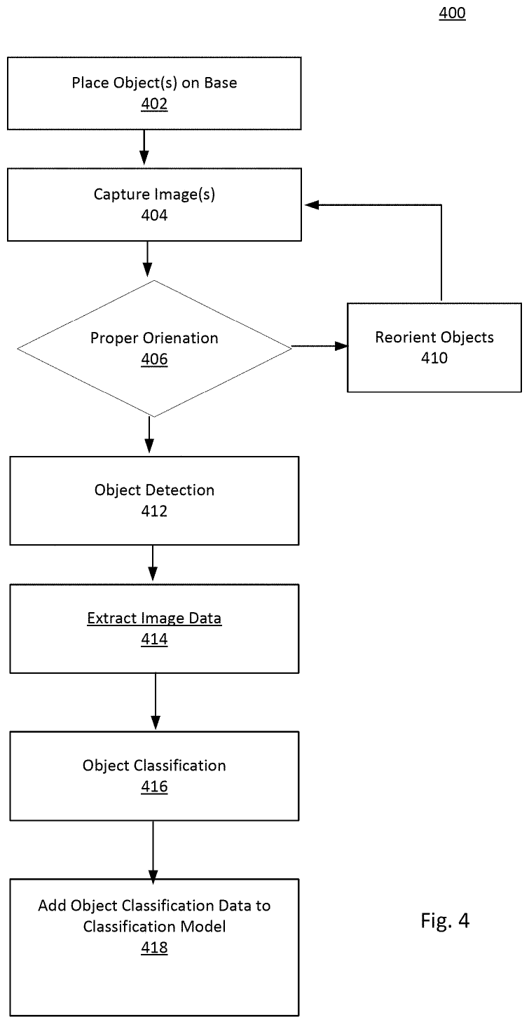

Referring to FIG. 4, an exemplary process 400 for classifying objects utilizing is now provided for illustrative purposes. In one embodiment, in step 402, a user places one or more objects on a base surface 102 (FIG. 1) and sensor 122 captures one or more images of the object(s) in step 404. In one example, the images may be captured as video or as photographs. If the images are captured as video, then the process may extract an optimal frame from the video (e.g. based on quality or resolution) for further processing. In step 406, a process executes to determine whether or not the objects are properly oriented such that the objects can be recognized from each other. For example, if objects are placed on top of each other or in front of each other, then the objects may not be able to be recognized relative to each other. Accordingly, in step 406, the user is prompted to reorient the objects in step 410 and another image is taken of the objects. In step 412, if the objects can be recognized from each other, then the image undergoes object detection. Object detection identifies the presence of one or more objects within the image. In step 414, the image data for the one or more objects is extracted from the master image. Accordingly, each object will have associated image data. In step 416, the image data for each object is provided to a deep learning module, which operates to classify each object. In step 418, the classification data is added to a classification model for system 100.

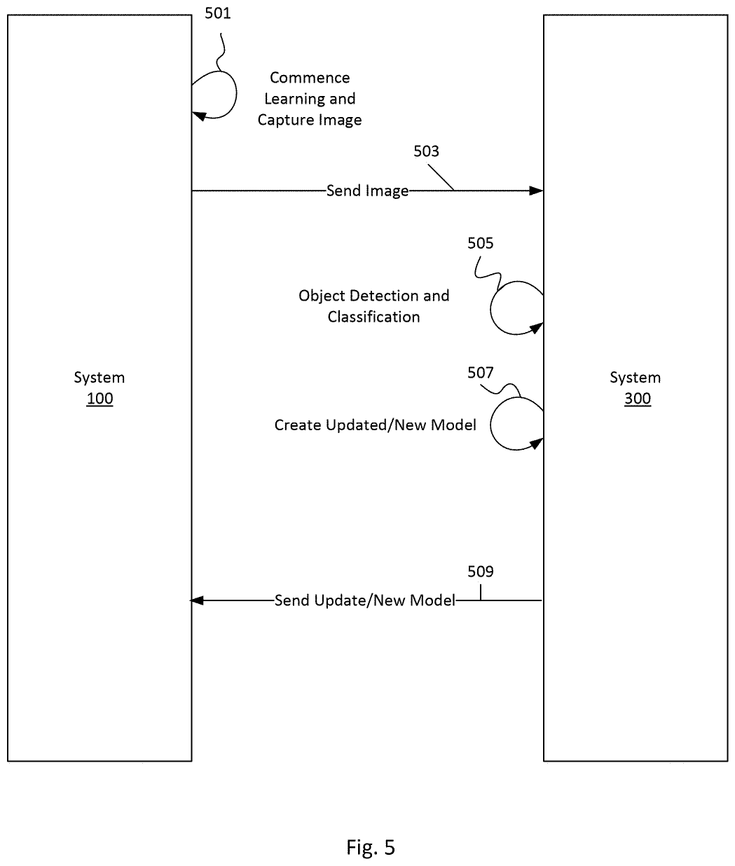

Referring to FIG. 5, an exemplary description of the interoperation of system 100 (FIG. 1) and system 300 (FIG. 3A) is now shown for illustrative purposes. In one example, system 100 comprises a point of sale (POS) system and system 300 comprises a system that is remote from system 100 (e.g. in the cloud) and is operated by a vendor or service provider for the operator of system 100. System 100 in one example includes one or more terminals that are used as check out terminals. As was discussed previously in connection with FIGS. 1 and 2, terminals 104 (FIG. 1) recognize objects placed on base surface 102 as part of the checkout process. To recognize such objects, system 100 utilizes a deep learning model created by system 300, as was discussed in connection with FIGS. 3A, 3B, and 4.

In one embodiment, a deep learning model is created or updated by system 300 when an operator of system 100 determines that it wants to add new items to its deep learning model. Accordingly, system 100 commences a learning process 501. As part of the learning process 501, an operator of the system places items on base surface 102 and an image 301 is captured (FIG. 3A). The image is sent to system 300 in 503. System 300 then performs object detection and classification in 505, as discussed in connection with FIGS. 3A, 3B, and 4. Upon completion of detection and classification 505, system 400 updates the model or creates a new model (in the case of a no pre-existing model) in 507 and sends the updated/new model to system 100 in 509 for utilization as described in connection with FIGS. 1 and 2.

In one example, the model is created by updating a pre-existing model to include the items that are trained as part of a particular process. For instance, a pre-existing model may have a dataset comprising classification index having n objects 304(1) . . . 304(n). An operator of system 100 may elect to train k new objects. Accordingly, system 100 captures image data for the k new objects and provides the image data to system 300, which performs object detection and classification on the k new objects. Upon completion of object detection and classification for the k new object, system 300 updates the classification to 304(1) . . . 304(n+k) by adding the classification data for the k new objects to the preexisting data model.

It should be noted the processes described in connection with FIG. 5 may be performed with respect to a single terminal or multiple terminals 104 on connection with a location. For example, multiple terminals 104 may perform the learning process for a single enterprise or premises. The learning model may be created/updated and then provided to the active terminals 104 for the enterprise. Such terminals 104 may be present in a single location or premises or be geographically distributed and connected over a network.

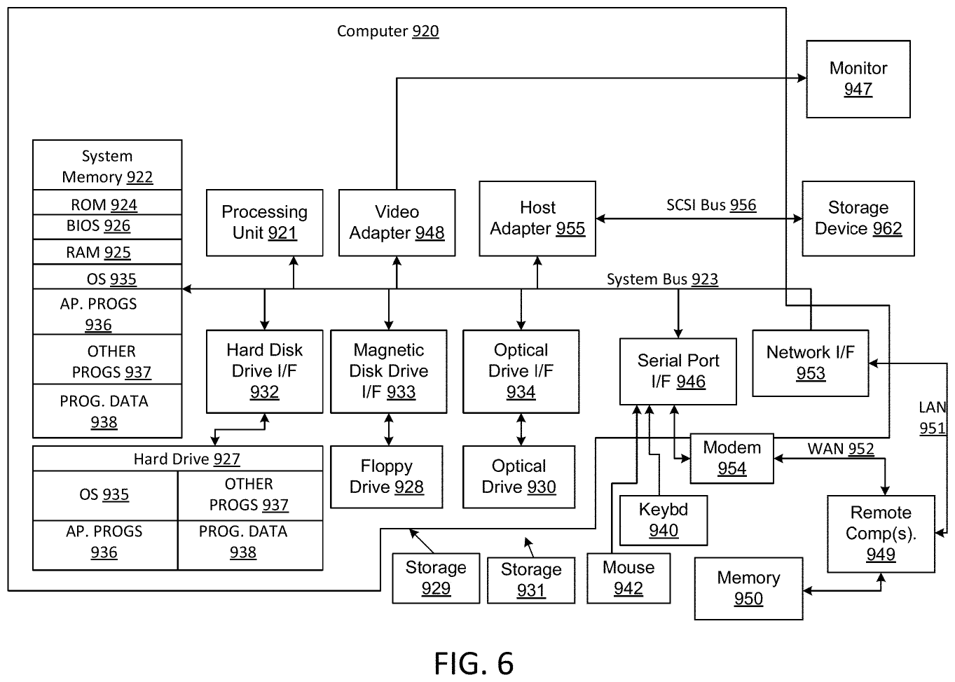

FIG. 6 and the following discussion are intended to provide a brief general description of a suitable computing environment in which the methods and systems disclosed herein or portions thereof may be implemented. Although not required, the methods and systems disclosed herein are described in the general context of computer-executable instructions, such as program modules, being executed by a computer, such as a client workstation, server, personal computer, or mobile computing device such as a smartphone. Generally, program modules include routines, programs, objects, components, data structures and the like that perform particular tasks or implement particular abstract data types. Moreover, it should be appreciated the methods and systems disclosed herein and/or portions thereof may be practiced with other computer system configurations, including hand-held devices, multi-processor systems, microprocessor-based or programmable consumer electronics, network PCs, minicomputers, mainframe computers and the like. A processor may be implemented on a single-chip, multiple chips or multiple electrical components with different architectures. The methods and systems disclosed herein may also be practiced in distributed computing environments where tasks are performed by remote processing devices that are linked through a communications network. In a distributed computing environment, program modules may be located in both local and remote memory storage devices.

FIG. 6 is a block diagram representing a system in which aspects of the methods and systems disclosed herein and/or portions thereof may be incorporated. As shown, the exemplary general purpose computing system includes a computer 920 or the like, including a processing unit 921, a system memory 922, and a system bus 923 that couples various system components including the system memory to the processing unit 921. The system bus 923 may be any of several types of bus structures including a memory bus or memory controller, a peripheral bus, and a local bus using any of a variety of bus architectures. The system memory includes read-only memory (ROM) 924 and random access memory (RAM) 925. A basic input/output system 926 (BIOS), containing the basic routines that help to transfer information between elements within the computer 920, such as during start-up, is stored in ROM 924.

The computer 920 may further include a hard disk drive 927 for reading from and writing to a hard disk (not shown), a magnetic disk drive 928 for reading from or writing to a removable magnetic disk 929, and an optical disk drive 930 for reading from or writing to a removable optical disk 931 such as a CD-ROM or other optical media. The hard disk drive 927, magnetic disk drive 928, and optical disk drive 930 are connected to the system bus 923 by a hard disk drive interface 932, a magnetic disk drive interface 933, and an optical drive interface 934, respectively. The drives and their associated computer-readable media provide non-volatile storage of computer readable instructions, data structures, program modules and other data for the computer 920. As described herein, computer-readable media is a tangible, physical, and concrete article of manufacture and thus not a signal per se.

Although the exemplary environment described herein employs a hard disk, a removable magnetic disk 929, and a removable optical disk 931, it should be appreciated that other types of computer readable media which can store data that is accessible by a computer may also be used in the exemplary operating environment. Such other types of media include, but are not limited to, a magnetic cassette, a flash memory card, a digital video or versatile disk, a Bernoulli cartridge, a random access memory (RAM), a read-only memory (ROM), and the like.

A number of program modules may be stored on the hard disk, magnetic disk 929, optical disk 931, ROM 924 or RAM 925, including an operating system 935, one or more application programs 936, other program modules 937 and program data 938. A user may enter commands and information into the computer 920 through input devices such as a keyboard 940 and pointing device 942. Other input devices (not shown) may include a microphone, joystick, game pad, satellite disk, scanner, or the like. These and other input devices are often connected to the processing unit 921 through a serial port interface 946 that is coupled to the system bus, but may be connected by other interfaces, such as a parallel port, game port, or universal serial bus (USB). A monitor 947 or other type of display device is also connected to the system bus 923 via an interface, such as a video adapter 948. In addition to the monitor 947, a computer may include other peripheral output devices (not shown), such as speakers and printers. The exemplary system of FIG. 4 also includes a host adapter 955, a Small Computer System Interface (SCSI) bus 956, and an external storage device 962 connected to the SCSI bus 956.

The computer 920 may operate in a networked environment using logical connections to one or more remote computers, such as a remote computer 949. The remote computer 949 may be a personal computer, a server, a router, a network PC, a peer device or other common network node, and may include many or all of the elements described above relative to the computer 920, although only a memory storage device 950 has been illustrated in FIG. 4. The logical connections depicted in FIG. 4 include a local area network (LAN) 951 and a wide area network (WAN) 952. Such networking environments are commonplace in offices, enterprise-wide computer networks, intranets, and the Internet.

When used in a LAN networking environment, the computer 920 is connected to the LAN 951 through a network interface or adapter 953. When used in a WAN networking environment, the computer 920 may include a modem 954 or other means for establishing communications over the wide area network 952, such as the Internet. The modem 954, which may be internal or external, is connected to the system bus 923 via the serial port interface 946. In a networked environment, program modules depicted relative to the computer 920, or portions thereof, may be stored in the remote memory storage device. It will be appreciated that the network connections shown are exemplary and other means of establishing a communications link between the computers may be used.

Computer 920 may include a variety of computer readable storage media. Computer readable storage media can be any available media that can be accessed by computer 920 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 920. Combinations of any of the above should also be included within the scope of computer readable media that may be used to store source code for implementing the methods and systems described herein. Any combination of the features or elements disclosed herein may be used in one or more examples.

In describing preferred examples of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method comprising:
using an image sensor to capture an image that includes a plurality of objects;
detecting presence and location data of the plurality of objects;
utilizing the image and the presence and location data to create individual representations of the plurality of objects;
classifying the plurality of objects through employment of the individual representations; and
updating a machine learning model with classification data generated by classifying the plurality of objects.

2. The method of claim 1, wherein the image sensor is a video camera.

3. The method of claim 1, wherein the machine learning model is a deep learning model.

4. The method of claim 1, wherein utilizing comprises cropping each of the plurality of objects from the image to create the individual representations.

5. The method of claim 1, wherein updating comprises adding classification information for the plurality of objects to a pre-existing machine learning model.

6. The method of claim 1, further comprising:
displaying the two-dimensional image on an output display device; and
using the individual representations to draw a boundary around each of the plurality of objects on the output display device.

7. The method of claim 1, wherein the image is a two-dimensional image.

8. A method for comprising:
using an image sensor, at a first location, to capture an image that includes a plurality of objects;
sending the image over a network to a second location;
detecting, at the second location, presence and location data of the plurality of objects;
utilizing the two-dimensional image and the presence and location data to create individual representations of the plurality of objects;
classifying the plurality of objects through employment of the individual representations;
updating a machine learning model with classification data generated by classifying the plurality of objects; and.
sending the machine learning model over the network to the first location.

9. The method of claim 8, further comprising:
loading the machine learning model at a user terminal of a point-of-sale system at the first location.

10. The method of claim 9, further comprising:
capturing a second image of a second plurality of objects at the point-of-sale system;
using the machine learning model to identify the second plurality of objects;
creating a checkout cart including the second plurality of objects; and
enabling the customer to purchase the second plurality of objects through the checkout cart.

11. The method of claim 8, further comprising:
drawing a boundary around each of the second plurality of objects on the output display device.

12. The method of claim 8, wherein the second image is a two-dimensional image.

13. The method of claim 8, wherein the image sensor is a video camera.

14. An apparatus comprising:
a processor; and
a memory coupled with the processor, the memory comprising executable instructions that when executed by the processor cause the processor to effectuate operations comprising:
using an image sensor to capture an image that includes a plurality of objects;
detecting presence and location data of the plurality of objects;
utilizing the two-dimensional image and the presence and location data to create individual representations of the plurality of objects;
classifying the plurality of objects through employment of the individual representations; and
updating a machine learning model with classification data generated by classifying the plurality of objects.

15. The apparatus of claim 14, wherein the image sensor is a video camera.

16. The apparatus of claim 14, wherein the machine learning model is a deep learning model.

17. The apparatus of claim 14, wherein utilizing comprises cropping each of the plurality of objects from the image to create the individual representations.

18. The apparatus of claim 14, wherein updating comprises adding classification information for the plurality of objects to a pre-existing machine learning model.

19. The apparatus of according to claim 14, wherein the operations further comprise:
displaying the two-dimensional image on an output display device; and
using the individual representations to draw a boundary around each of the plurality of objects on the output display device.

20. The apparatus of claim 14, wherein the image is a two-dimensional image.
